(19) United States
(12) Patent Application Publication
(10) Pub. No.: US 2005/0175182 A1
(43) Pub. Date: Aug. 11, 2005

(54) Encryption key device, encryption device and decryption device

(76) Inventors: Osamu Ueno, Shizuoka-ken (JP); Yoshikazu Nishino, Shizuoka-ken (JP); Fumiaki Nishiyama, Shizuoka-ken (JP); Rei Isogai, Shizuoka-ken (JP); Yasunori Kitajima, Shizuoka-ken (JP); Miho Urano, Shizuoka-ken (JP)

Correspondence Address: Finnegan, Henderson, Farabow,;Garrett & Dunner, L.L.P., 1300 I Street, N.W., Washington, DC, 20005-3315, US

(21) Appl. No.: 10/969,342

(22) Filed: Oct. 21, 2004

(30) Foreign Application Priority Data
Oct. 21, 2003 (JP) JP2003-360818

(51) Int. Cl. H04L 9/00

(52) U.S. Cl. 380/277

(57) ABSTRACT

An encryption key device can be freely attached to and detached from an information processor encrypting or decrypting data and includes a memory, a pseudorandom number generator, and a controller. The memory stores an application program to operate the encryption key device and a group ID specifying permission for use of the encryption key device. The pseudorandom number generator generates a pseudorandom number according to an encryption function using the group ID stored in the memory as an initial value of the encryption function. The controller causes the pseudorandom number generator to generate the pseudorandom number according to data size received from the information processor operating according to the application program and sends the generated pseudorandom number and the group ID read from the memory to the information processor.

### CROSS REFERENCE TO RELATED APPLICATIONS

This application is based upon and claims the benefit of priority from prior Japanese Patent Application P2003-360818 filed on Oct. 21, 2003; the entire contents of which are incorporated by reference herein.

### BACKGROUND OF THE INVENTION

1. Field of the Invention

The present invention relates to an encryption key device used for encrypting and decrypting data and to an encryption device and a decryption device using the same.

2. Description of the Related Art

In recent years, as an interface for linking comparatively low-speed peripherals such as a keyboard, a mouse, a speaker, a modem, and a printer with a personal computer, the USB (Universal Serial Bus) interface, which uses standardized connectors and cables, has been used.

An encryption device and a decryption device have been known which are composed of a USB key (peripheral device) having the USB interface and a personal computer with the USB key attached thereto and encrypt or decrypt data. For example, the aforementioned encryption device and decryption device are disclosed in the Japanese Patent Laid-Open publication No. 2003-216037. These encryption device and decryption device adopt a chaos encryption system, and the USB key generates a pseudorandom number of a chaotic sequence and sends the same to the personal computer. The personal computer encrypts and decrypts data according to the pseudorandom number received from the USB key.

With these encryption device and decryption device, various types of data can be encrypted on a file basis or folder basis. The encrypted data cannot be decrypted without the same USB key used in the encryption to enable higher security.

The Japanese Patent Laid-Open publication No. 9-282235 discloses an access control method to encrypt data already stored in a PC card in use in the following manner. When an encryption request to use the PC card which is not encrypted as a cryptographic card is issued from a user, the user is urged to enter a password used to generate key data for encryption and decryption of the PC card. The password entered by the user is then stored in the PC card, and the key data is generated by use of the entered data to be presented to the user. Thereafter, based on the generated key data, a process to encrypt data already stored in the attached PC card and a process to restore the encrypted data in the PC card are carried out.

The Japanese Patent Laid-Open Publication No. 9-238132 describes a portable terminal communication system in which an IC card and a higher-level device each include a random number generator generating a first random number, a random number generator generating a second random number, a secret key recognized only by a right IC card and a right higher-level device, an encryption/decryption processor selectively performing an encryption or decryption process, and an encryption/decryption key generator generating from a secret key an encryption/decryption key required for real encryption/decryption when a process to read/write data is performed. The IC card further includes a storage unit for storing data used in various types of applications.

In the aforementioned encryption device and decryption device of the Japanese Patent Laid-Open publication No. 2003-216037, an application program (hereinafter, referred to as just an application) for the user to use the USB key is previously installed in the personal computer. In the case of using the USB key, this application is started, and the USB key is attached to the personal computer. The user is then required to enter an ID for identification required by the application on the personal computer. Accordingly, the encryption device and decryption device involve problems in the troublesome operation to enter the ID and lower security due to an increase in likelihood that a third party could see the ID.

The data is encrypted according to an instruction of the user (for example, drag-and-drop). The encrypted data obtained by this encryption is added to the ID and then saved in the personal computer. The instruction for encryption is troublesome, and there is a possibility that the ID in the personal computer could be seen by a third party, leading to lower security.

The Japanese Patent Laid-Open publications Nos. 9-282235 and 9-238132 include similar problems and are low security.

### SUMMARY OF THE INVENTION

The present invention was made to solve the aforementioned problems, and an object thereof is to provide an encryption key device capable of being easily operated and offering high security and an encryption device and a decryption device using the same.

In order to achieve the aforementioned object, a first aspect of the present invention is an encryption key device capable of being freely attached to and detached from an information processor encrypting or decrypting data, and the encryption key device includes: a memory storing an application program to operate the encryption key device and a group ID specifying permission for use of the encryption key device; a pseudorandom number generator generating a pseudorandom number according to an encryption function using the group ID stored in the memory as an initial value of the encryption function; and a controller causing the pseudorandom number generator to generate the pseudorandom number according to data size received from the information processor operating according to the application program and sending the generated pseudorandom number and the group ID read from the memory to the information processor.

According to the first aspect of the present invention, the application program to operate the encryption key device and the group ID specifying permission for use of the encryption key device are stored in the memory. The application program operating when the encryption key device is attached to the information processor can be configured to read the group ID from the memory and judge the permission for use of the encryption key device. In this case, the user does not need to enter the group ID, thus facilitating the operation of using the encryption key device. In addition, there is no likelihood that the group ID could be seen by a third party, and high security can be obtained.

In the encryption key device according to the first aspect of the present invention, the memory may be configured so as to be freely attached to and detached from the body of the encryption key device.

Since the memory is freely attached to and detached from the body of the encryption key device, if the memory is held by each individual, application of this encryption key device can further increase the security of the information processor constituting the encryption device or decryption device.

A second aspect of the present invention is an encryption device including: an information processor encrypting data; and an encryption key device capable of being freely attached to and detached from the information processor. The encryption key device includes: a memory storing an application program to operate the encryption key device and a group ID specifying permission for use of the encryption key device; and a pseudorandom number f generating a pseudorandom number according to an encryption function using the group ID stored in the memory as an initial value of the encryption function. The information processor reads the application program from the memory of the encryption key device to activate the application program when the encryption key device is attached thereto and sends data size of not-encrypted plaintext data to the encryption key device by processing of the activated application program, and the encryption key device causes the pseudorandom number generator to generate the pseudorandom number according to the data size received from the information processor and sends the generated pseudorandom number to the information processor. The information processor then encrypts the plaintext data using the pseudorandom number sent from the encryption key device as a key and adds the group ID read from the memory of the encryption key device to encrypted data generated by the encryption to generate a cryptographic file.

According to the second aspect of the present invention, the application program to operate the encryption key device and the group ID specifying the permission for use of the encryption key device are stored in the memory of the encryption key device. The information processor reads the application program from the encryption key device to activate the application program when the encryption key device is attached to the information processor. The application program reads the group ID from the memory and judges the permission for use of the encryption key device. When use of the encryption key device is allowed, the application program performs encryption. Accordingly, the user does not need to enter the group ID, facilitating the operation of using the encryption key device. In addition, there is no likelihood that the group ID could be seen by a third party, and high security can be obtained.

A third aspect of the present invention is a decryption device including: an information processor decrypting data; and an encryption key device capable of being freely attached to and detached from the information processor. The encryption key device includes: a memory storing an application program to operate the encryption key device and a group ID specifying permission for use of the encryption key device; and a pseudorandom number generator generating a pseudorandom number according to an encryption function using the group ID stored in the memory as an initial value of the encryption function. The information processor reads the application program from the memory of the encryption key device to activate the application program when the encryption key device is attached thereto and sends data size of encrypted data included in a cryptographic file to the encryption key device by processing of the activated application program, and the encryption key device causes the pseudorandom number generator to generate the pseudorandom number according to the data size received from the information processor and sends the generated pseudorandom number and the group ID read from the memory to the information processor. The information processor decrypts the encrypted data using the pseudorandom number sent from the encryption key device as a key when the group ID sent from the encryption key device matches the group ID included in the cryptographic file to generate plaintext data.

According to the third aspect of the present invention, the application program to operate the encryption key device and the group ID specifying the permission for use of the encryption key device are stored in the memory of the encryption key device. The information processor reads the application program from the encryption key device to activate the application program when the encryption key device is attached to the information processor. The application program reads the group ID from the memory and judges the permission for use of the encryption key device. When use of the encryption key device is permitted, the application program performs decryption. Accordingly, the user does not need to enter the group ID, facilitating the operation of using the encryption key device. In addition, there is no likelihood that the group ID could be seen by a third party, and high security can be obtained.

A fourth aspect of the present invention is an encryption key device capable of being freely attached to and detached from an information processor encrypting and decrypting data, and the encryption key device includes: a memory storing an application program to operate the encryption key device, a group ID specifying permission for use of the encryption key device, and automatic encryption setting information specifying a destination where encrypted data encrypted are saved and including a data area where data can be written; a pseudorandom number generator generating a pseudorandom number according to an encryption function using the group ID stored in the memory as an initial value of the encryption function; and a controller causing the pseudorandom number generator to generate the pseudorandom number according to data size received from the information processor operating according to the application program when the encryption key device is attached to the information processor, sending the generated pseudorandom number and the group ID read from the memory to the information processor, and controlling exchange of data between the data area of the memory and the information processor.

According to the fourth aspect of the present invention, the application program to operate the encryption key device, the group ID specifying the permission for use of the encryption key device, and the automatic encryption setting information specifying a destination where the encrypted data encrypted is saved are stored, and the memory includes the data area where data can be written. The application program operating when the encryption key device is attached to the information processor can be configured to determine the destination where the encrypted data is saved to be the memory of the encryption key device based on the automatic encryption setting information. In this case, the user does not need to specify where to save the encrypted data, facilitating the operation of using the encryption key device. In addition, there is no likelihood that the group ID could be seen by a third party, and high security can be obtained.

A fifth aspect of the present invention is an encryption device, including: an information processor encrypting data; and an encryption key device capable of being freely attached to and detached from the information processor. The encryption key device includes: a memory storing an application program to operate the encryption key device, a group ID specifying permission for use of the encryption key device, and automatic encryption setting information specifying a destination where encrypted data encrypted is saved and including a data area where data can be written; and a pseudorandom number generator generating a pseudorandom number according to an encryption function using the group ID stored in the memory as an initial value of the encryption function. The information processor reads an application program from the memory of the encryption key device to activate the application program when the encryption key device is attached thereto and sends data size of not-encrypted plaintext data to the encryption key device by processing of the activated application program, and the encryption key device causes the pseudorandom number generator to generate the pseudorandom number according to the data size received from the information processor and sends the generated pseudorandom number to the information processor. The information processor then encrypts the plaintext data using the pseudorandom number sent from the encryption key device as a key, adds a group ID read from the memory of the encryption key device to encrypted data generated by the encryption to generate a cryptographic file, and sends the generated cryptographic file to the data area of the memory when the automatic encryption setting information read from the memory of the encryption key device specifies the memory of the encryption key device as a destination where the cryptographic file is saved.

According to the fifth aspect of the present invention, the encryption key device stores in the memory the application program to operate the encryption key device, the group ID specifying the permission for use of the encryption key device, and the automatic encryption setting information specifying the destination where the encrypted data is saved, and the memory includes the data area where data can be written. Accordingly, the application program operating when the encryption key device is attached to the information processor can determine the destination where the cryptographic file is saved to be the memory of the encryption key device based on the automatic encryption setting information. The user therefore does not need to specify the destination where the encrypted data is saved, facilitating the operation of using the encryption key device. In addition, the cryptographic file is saved in the encryption key device. Accordingly, there is no likelihood that the encrypted data and the group ID could be seen by a third party, and high security can be obtained.

A sixth aspect of the present invention is a decryption device including: an information processor decrypting data; and an encryption key device capable of being freely attached to and detached from the information processor. The encryption key device includes: a memory storing an application program to operate the encryption key device, a group ID specifying permission for use of the encryption key device, and automatic decryption setting information specifying a destination where plaintext data decrypted is saved and including a data area where data can be written; and a pseudorandom number generator generating a pseudorandom number according to an encryption function using the group ID stored in the memory as an initial value of the encryption function. The information processor reads an application program from the memory of the encryption key device to activate the application program when the encryption key device is attached thereto and sends data size of encrypted data included in a cryptographic file to the encryption key device by processing of the activated application program, and the encryption key device causes the pseudorandom number generator to generate the pseudorandom number according to the data size received from the information processor and sends the generated pseudorandom number and a group ID read from the memory to the information processor. The information processor then decrypts the encrypted data using the pseudorandom number sent from the encryption key device as a key to generate plaintext data when the group ID sent from the encryption key device matches the group ID included in the cryptographic file and sends the generated plaintext data to the data area of the memory when the automatic decryption setting information read from the memory of the encryption key device specifies the memory of the encryption key device as a destination where the generated plaintext data is saved.

According to sixth aspect of the present invention, the encryption key device stores in the memory the application program to operate the encryption key device, the group ID specifying the permission for use of the encryption key device, and the automatic decryption setting information specifying a destination where the plaintext data is saved, and the memory includes the data area where data can be written. Accordingly, the application program operating when the encryption key device is attached to the information processor can determine the destination where the plaintext data is saved to be the memory of the encryption key device based on the automatic decryption setting information. The user therefore does not need to specify the destination where the plaintext data is saved, facilitating the operation of using the encryption key device. In addition, the plaintext data is saved in the encryption key device. Accordingly, there is no likelihood that the plaintext data and the group ID could be seen by a third party, and high security can be obtained.

### BRIEF DESCRIPTION OF THE DRAWINGS

FIG. 1 is a block diagram showing a configuration of an encryption key device according to a first embodiment of the present invention and an encryption device or decryption device using the same.

FIG. 2 is a diagram showing a structure of a memory included in a USB key shown in FIG. 1.

FIG. 3 is a sequence diagram for explaining an operation of the encryption key device according to the first embodiment of the present invention and the encryption device using the same.

FIG. 4 is a view for explaining an operation of encryption in the encryption key device according to the first embodiment of the present invention and the encryption device using the same.

FIG. 5 is a view showing a structure of a cryptographic file generated by the encryption key device according to the first embodiment of the present invention and the encryption device using the same.

FIG. 6 is a sequence diagram for explaining an operation of the encryption key device according to the first embodiment of the present invention and the decryption device using the same.

FIG. 7 is a flowchart showing a detail of a process to check a group ID of FIG. 6.

FIG. 8 is a view for explaining an operation of decryption in the encryption key device according to the first embodiment of the present invention and the decryption device using the same.

FIG. 9 is a diagram showing a structure of a memory included in a USB key as an encryption key device according to a second embodiment of the present invention.

FIG. 10 is a sequence diagram for explaining an operation of an encryption key device according to the second embodiment of the present invention and the decryption device using the same.

FIG. 11 is a view showing a structure of a memory included in a USB key as an encryption key device according to a third embodiment of the present invention.

FIG. 12 is a sequence diagram showing an operation of the encryption key device according to the third embodiment of the present invention and a decryption device using the same.

FIG. 13 is a block diagram showing a structure of a USB key as an encryption key device according to a fourth embodiment of the present invention.

### DETAILED DESCRIPTION OF EMBODIMENTS

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

In the following description specific details are set forth, such as specific materials, process and equipment in order to provide thorough understanding of the present invention. It will be apparent, however, to one skilled in the art that the present invention may be practiced without these specific details. In other instances, well-known manufacturing materials, process and equipment are not set forth in detail in order not unnecessary obscure the present invention.

A description is given of an encryption key device according to embodiments of the present invention and an encryption device and a decryption device using the same in detail with reference to the drawings. Hereinafter, a USB key is used as the encryption key device of the present invention, and each of the encryption device and decryption device is composed of the USB key and a personal computer.

(First Embodiment)

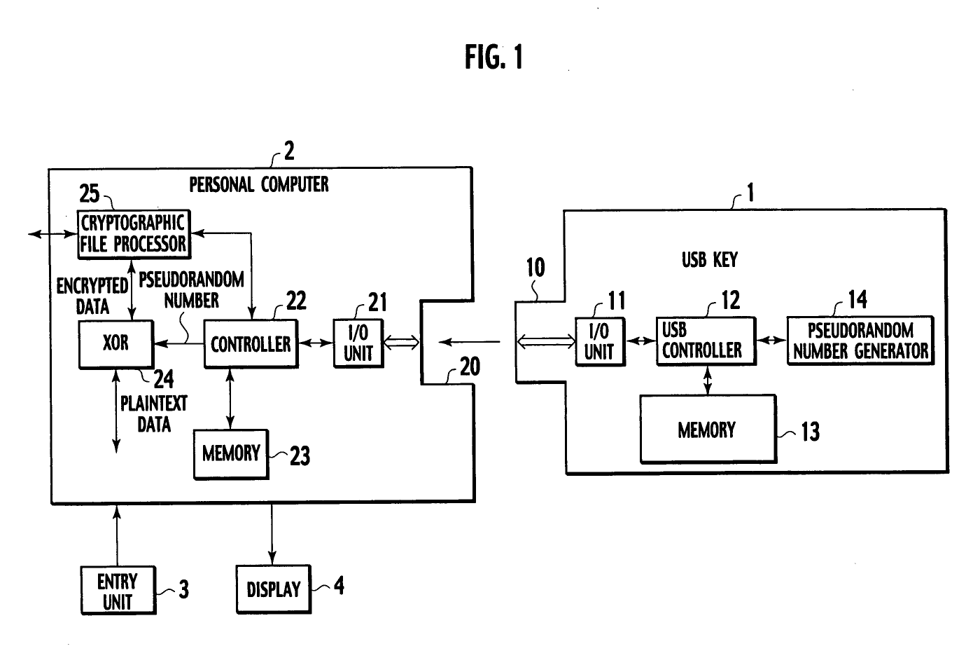

FIG. 1 is a block diagram showing a configuration of an encryption key device according to a first embodiment of the present invention and an encryption device or a decryption device using the same.

A USB key 1 corresponds to an encryption key device of the present invention and is formed to be compact so as to be carried by individuals. This USB key 1 is structured so as to be freely attached to and detached from a personal computer 2. The personal computer 2 corresponds to an information processor of the present invention. When the USB key 1 is attached to the personal computer 2, the personal computer 2 sends data size of not-encrypted plaintext data to the USB key 1 and encrypts the plaintext data with a pseudorandom number as a key to generate encrypted data. The pseudorandom number is sent from the USB key 1 in response to the data size. The information processor of the present invention can be, not limited to the personal computer, a portable terminal such as a mobile phone or a PDA.

The USB key 1 is compliant with the USB mass storage class of USB standards and includes a ROM area and a rewritable area. The personal computer 2 is configured to recognize the ROM area of the USB key 1 as a CD-ROM and the rewritable area as a removable disk. Accordingly, it is not required to install a new driver dedicated to the USB key 1 in the personal computer 2, and a standard USB driver already installed in an operating system (OS) adopted by many personal computers can be used as it is.

In a predetermined portion of a case of the USB key 1, a key protrusion 10 forming a USB connector is provided. This key protrusion 10 is inserted to a computer recess 20 forming a USB connector of the personal computer 2. This enables the USB key 1 and the personal computer 2 to be electrically connected to each other and exchange data.

The USB key 1 includes an input/output unit 11, a USB controller 12, a memory 13, and a pseudorandom number generator 14.

The input/output unit 11 is connected to the personal computer 2 through the key protrusion 10 and to the USB controller 12. The input/output unit 11 controls exchange of data between the USB key 1 and the personal computer 2.

The USB controller 12 is composed of, for example, a microprocessor and controls the entire USB key 1. Processes executed by the USB controller 12 are described in detail below.

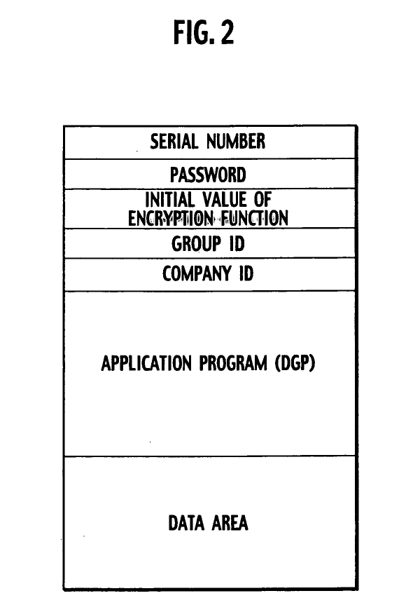

The memory 13 is composed of, for example, a flash memory and, as shown in FIG. 2, stores a serial number uniquely given to the USB key 1, a password given to a user of the USB key 1, a group ID given to a group composed of a plurality of persons like a cooperation, which is an initial value of an encryption function, a company ID indicating a company name, an application program, and a like. The memory 13 includes a data area which data can be written in and read from and can be arbitrarily used by the user.

The group ID is given to a plurality of the USB keys 1. In a usage pattern of the USB key 1 in which the group ID is used (hereinafter, referred to as a group mode), encrypted data can be exchanged among a plurality of persons holding the USB keys 1 which store a same group ID.

The application program is a program for the user to operate the USB key 1, and hereinafter, sometimes referred to as a data guard program (DGP). When the USB key 1 is attached to the personal computer 2, this data guard program is automatically transferred to the personal computer 2 to be started and used to encrypt or decrypt data using the USB key 1.

The pseudorandom number generator 14 generates a pseudorandom number of a chaotic sequence of a size corresponding to a data size of plaintext data sent from the personal computer 2 according to the encryption function using the group ID, which is the initial value stored in the memory 13, as an initial value of the encryption function.

The pseudorandom number generator 14 can generate a plurality of types of pseudorandom numbers by varying the group ID which is the initial value of the encryption function. Accordingly, a plurality of types of the USB key 1 can be produced by storing group IDs which are different initial values in the memory 13 of the USB key 1. The encryption function used by the pseudorandom number generator 14 can be, in addition to the function generating pseudorandom numbers of a chaotic sequence, various types of functions capable of generating different pseudorandom numbers depending on the group ID as the initial value.

The personal computer 2 includes an input/output unit 21, a controller 22, a memory 23, an exclusive OR operating unit 24 (hereinafter, referred to as XOR), and a cryptographic file processor 25. The personal computer 2 is connected to an entry unit 3 in which the plaintext data and other various types of data are entered and a display 4 for displaying various types of information.

The input/output unit 21 is connected to the USB key 1 through the computer recess 20 and connected to the controller 22. The input/output unit 21 controls exchange of data between the USB key 1 and the personal computer 2.

The controller 22 is composed of, for example, a microprocessor and controls the entire personal computer 2. Processes executed by the controller 22 are described later in detail. The memory 23 stores an individual password entered from the entry unit 3, various types of data, and the like.

When the personal computer 2 operates as the encryption device, the XOR 24 executes an exclusive OR operation of the pseudorandom number received from the controller 22 and the plaintext data generated in the personal computer 2 to generate encrypted data, or encrypts the plaintext data, and then sends the generated encrypted data to the cryptographic file processor 25. On the other hand, when the personal computer 2 operates as the decryption device, the XOR 24 executes an exclusive OR operation of the pseudorandom number received from the controller 22 and the encrypted data received from the cryptographic file processor 25 to decrypt the encrypted data to the plaintext data.

Next, a description is given to operations of the encryption key device according to the thus-configured first embodiment of the present invention and the encryption device and decryption device using the same.

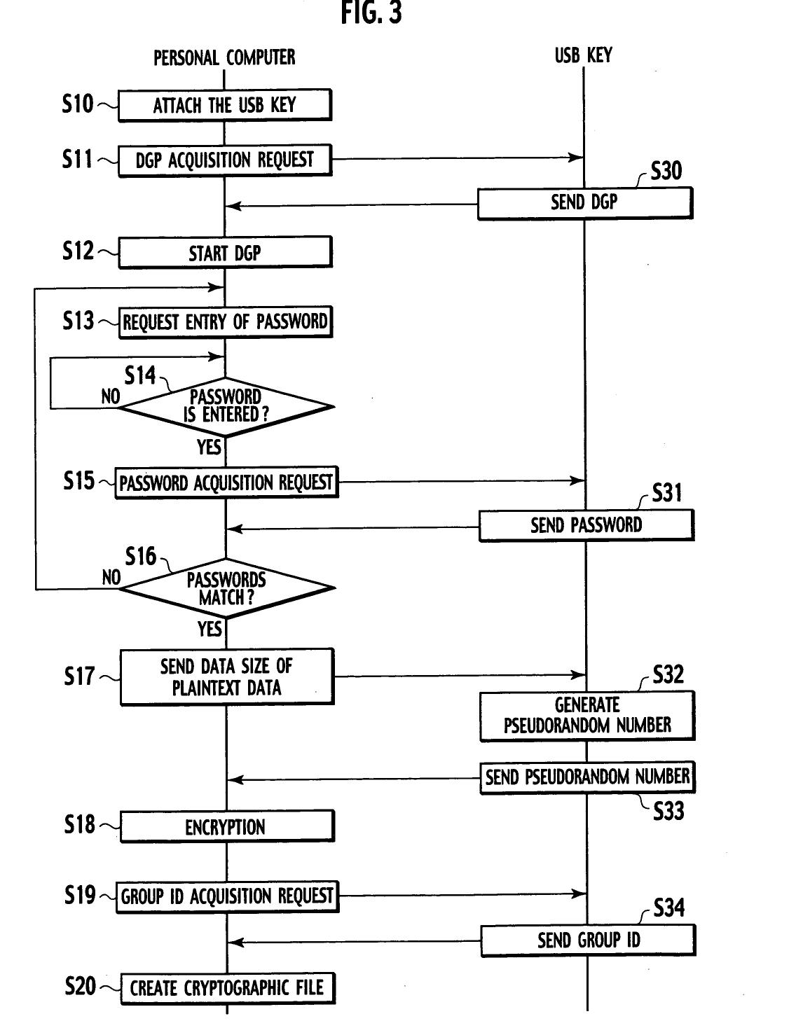

First, a description is given of an operation in the case where the personal computer 2 functions as the encryption device with reference to a sequence diagram shown in FIG. 3.

In the case of encrypting plaintext data, first, the USB key 1 is attached to the personal computer 2 (step S10). When the USB key 1 is attached, the personal computer 2 sends a data guard program (DGP) acquisition request to the USB key 1 (step S11). Specifically, on receiving an attachment signal indicating that the USB key 1 has been attached from the input/output unit 21, the controller 22 creates a command indicating a request to acquire the data guard program and sends the same to the USB key 1 through the input/output unit 21.

On receiving the data guard program acquisition request from the personal computer 2, the USB key 1 sends the data guard program (DGP) to the personal computer 2 (step S30). Specifically, on receiving the command indicating the request to acquire the data guard program from the personal computer 2 through the input/output unit 11, the USB controller 12 reads the data guard program which is stored in the memory 13 as the application program and sends the same to the personal computer 2 through the input/output unit 11.

On receiving the data guard program, the personal computer 2 starts the data guard program (step S12). An autorun function of the data guard program is thus implemented.

The personal computer 2 operating according to the data guard program first displays a screen requesting entry of the password on the display 4 (step S13). Thereafter, the personal computer 2 goes into a state of waiting for the password to be entered (step S14). When the password is entered from the entry unit 3 in this state, the personal computer 2 sends the password acquisition request to the USB key 1 (step S15).

In the USB key 1 having received the password acquisition request from the personal computer 2, the USB controller 12 reads the password from the memory 13 and sends the same to the personal computer 2 (step S31).

In the personal computer 2 having received the password from the USB key 1, the controller 22 examines whether the password entered from the entry unit 3 matches the password received from the USB key 1 (step S16). When it is judged that the passwords do not match each other, the sequence returns to the step S13. The personal computer 2 again displays the screen requesting entry of the password and goes into the state of waiting for entry.

On the other hand, when the passwords are judged to match each other in the step S16, next, the personal computer 2 sends data size of the plaintext data to the USB key 1 (step S17).

In the USB key 1 having received the data size of the plaintext data, the USB controller 12 activates the pseudorandom number generator 14. The pseudorandom number generator 14 generates a pseudorandom number of a chaos series of a size corresponding to the data size of the plaintext data sent from the personal computer 2 according to the encryption function using, as the initial value of the encryption function, the group ID which is the initial value stored in the memory 13 (step S32). Next, the USB controller 12 sends the pseudorandom number generated by the pseudorandom number generator 14 to the personal computer 2 (step S33).

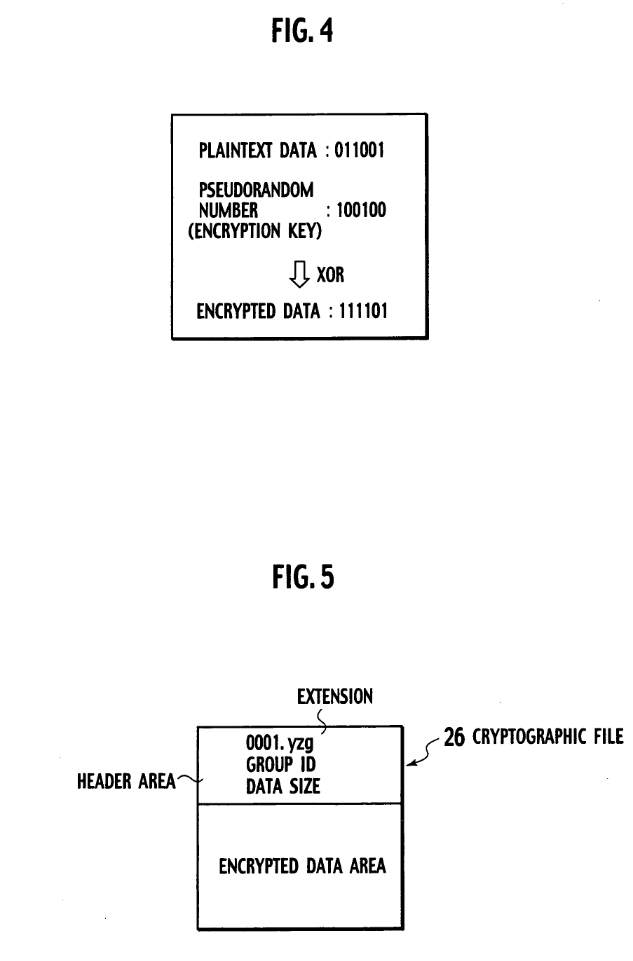

In the personal computer 2 having received the pseudorandom number, the controller 22 sends the received pseudorandom number to the XOR 24. The XOR 24 executes an exclusive OR operation of the pseudorandom number from the controller 22 and the plaintext data to generate encrypted data for encryption (step S18). In the process of step S18, for example, as shown in FIG. 4, when the plaintext data is “011001” and the pseudorandom number as the encryption key is “100100”, these values are EXORed to generate the encrypted data “111101”. The thus generated encrypted data is sent to the cryptographic file processor 25.

Next, the personal computer 2 sends the group ID acquisition request to the USB key 1 (step S19). In the USB key 1 having received the group ID acquisition request from the personal computer 2, the USB controller 12 reads the group ID from the memory 13 and sends the same to the personal computer 2 (step S34).

In the personal computer 2 having received the group ID, a cryptographic file is created (step S20). Specifically, the controller 22 of the personal computer 2 sends the group ID received from the USB key to the cryptographic file processor 25. In addition, the controller 22 calculates the data size of the encrypted data and sends the calculated data size to the cryptographic file processor 25.

The cryptographic file processor 25 generates a cryptographic file 26 including a header area and an encrypted data area as shown in FIG. 5. The encrypted data area stores the encrypted data received from the XOR 24. The header area stores the group ID and data size received from the controller 22 and a file name. The file name is followed by an extension “yzg”, which indicates a file encrypted in the group mode. When the file is encrypted in a normal mode (other than the group mode), the file name is followed by another extension “yzk”. The thus generated cryptographic file 26 is stored in a not-shown storage unit of the personal computer 2 or the memory 13 of the USB key 1.

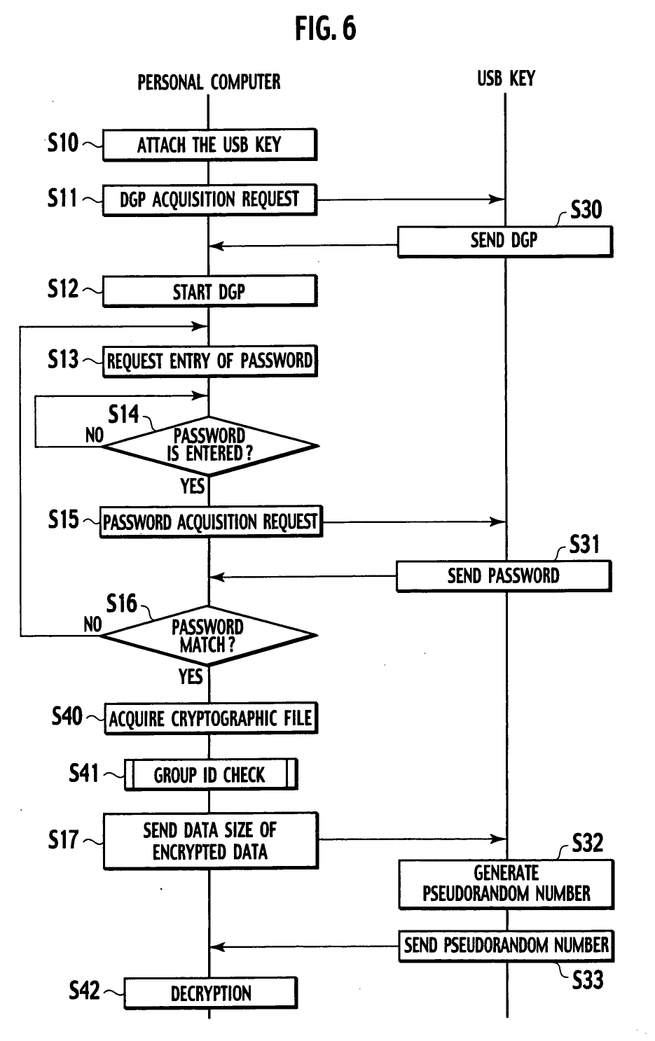

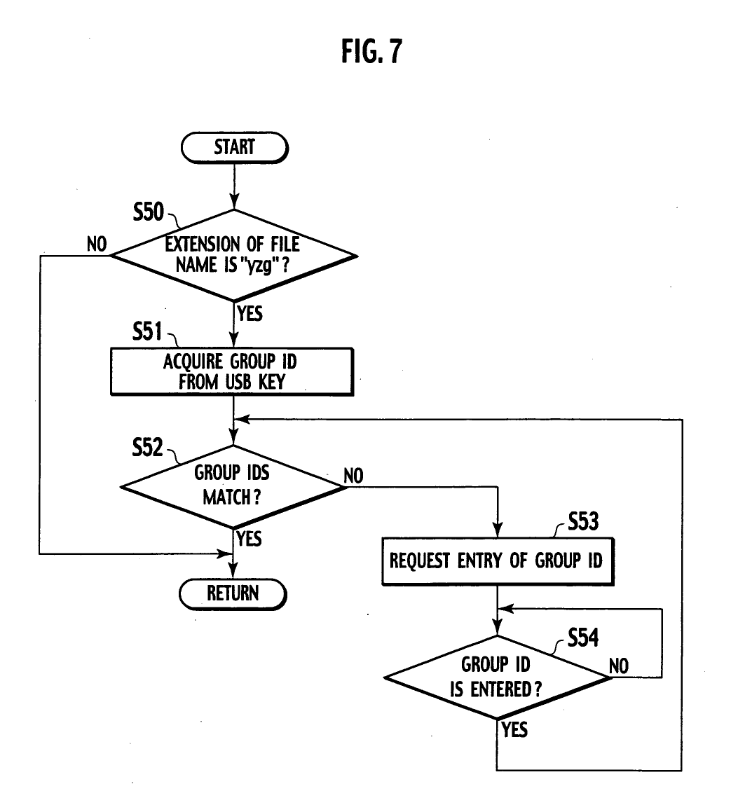

Next, a description is given of an operation when the personal computer 2 functions as the decryption device with reference to a sequence diagram shown in FIG. 6 and a flowchart shown in FIG. 7. Processes same as the aforementioned encryption processes are given same numerals as the numerals shown in FIG. 2, and the description thereof are omitted.

In the case of decrypting the encrypted data, first the USB key 1 is attached to the personal computer 2 (step S10). When the USB key 1 is attached, the personal computer 2 sends the data guard program (DGP) acquisition request to the USB key 1 (step S11). Upon receiving the data guard program acquisition request from the personal computer 2, the USB key 1 sends the data guard program (DGP) to the personal computer 2 (step S30). Upon receiving the data guard program, the personal computer 2 starts the same (step S12). The autorun function of the data guard program is thus implemented.

The personal computer 2 operating according to the data guard program first displays the screen requesting entry of the password on the display 4 (step S13). Thereafter, the personal computer 2 goes into a state of waiting for the password to be entered (step S14). When the password is entered from the entry unit 3 in this state, the personal computer 2 sends the password acquisition request to the USB key 1 (step S15). In the USB key 1 having received the password acquisition request from the personal computer 2, the USB controller 12 reads the password from the memory 13 and sends the same to the personal computer 2 (step S31).

In the personal computer 2 having received the password from the USB key 1, the controller 22 examines whether the password entered from the entry unit 3 matches the password received from the USB key 1 (step S16). When it is judged that the passwords do not match each other, the sequence returns to the step S13. The personal computer 2 displays again the screen requesting entry of the password and goes into the state of waiting for entry.

On the other hand, when it is judged that the passwords match each other in the step S16, the personal computer 2 acquires the cryptographic file to be decrypted (step S40). Specifically, the cryptographic file processor 25 retrieves the cryptographic file stored in the not-shown storage unit or the memory 13 of the USB key 1 and sends the file name, group ID, and data size stored in the header area thereof to the controller 22.

Next, the controller 22 performs a process to check the group ID (step S41). In this process to check the group ID, first, it is examined whether the extension of the file name retrieved from the cryptographic file processor 25 is “yzg”, that is, whether the cryptographic file is encrypted in the group mode (step S50) as shown in a flowchart shown in FIG. 7. When the extension of the file name is judged not to be “yzg”, checking the group ID is unnecessary, and the sequence returns from the routine of the process to check the group ID.

On the other hand, when the extension of the file name is judged to be “yzg” in the step S50, the personal computer 2 acquires the group ID from the USB key 1 (step S51). Specifically, the controller 22 of the personal computer 2 sends the group ID acquisition request to the USB key 1. In the USB key 1 having received the group ID acquisition request from the personal computer 2, the USB controller 12 reads the group ID from the memory 13 and sends the same to the personal computer 2.

In the personal computer 2 having received the group ID, the controller 22 sends the data size of the encrypted data acquired from the cryptographic file processor 25 to the USB key 1 (step S17). In the USB key having received the data size of the encrypted data, the USB controller 12 causes the pseudorandom number generator 14 to generate a pseudorandom number (step S32) and sends the generated pseudorandom number to the personal computer 2 (step S33).

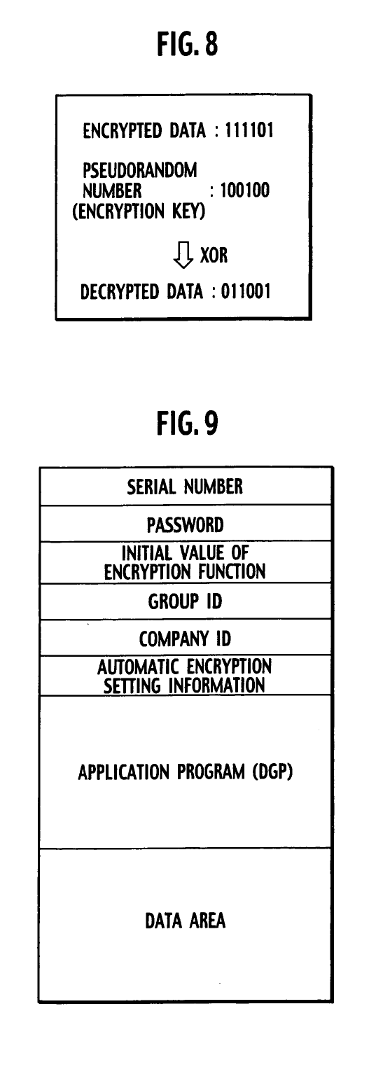

In the personal computer 2 having received the pseudorandom number, the controller 22 sends the received pseudorandom number to the XOR 24. The XOR 24 executes an exclusive OR operation of the pseudorandom number from the controller 22 and the encrypted data from the cryptographic file processor 25 to generate the plaintext data, or performs decryption (step S42). In the process of the step S42, for example, as shown in FIG. 8, when the encrypted data is “111101” and the pseudorandom number as the cryptographic key is “100100”, these values are EXORed to generate the plain text “011001”.

As described above, with the USB key 1 as the encryption key device according to the first embodiment of the present invention, the data guard program for operating the USB key 1 and the group ID for specifying permission for use of the USB key 1 in the group mode are stored in the memory 13. The data guard program operating when the USB key 1 is attached to the personal computer 2 can be configured to read the group ID from the memory 13 and judge the permission for use of the USB key 1. In this case, the user does not need to enter the group ID, facilitating the operation of using the USB key 1. In addition, there is no likelihood that the group ID could be seen by a third party, and high security can be obtained.

With the encryption device composed of the USB key 1 and the personal computer 2, the data guard program for operating the USB key 1 and the group ID for specifying the permission for use of the USB key 1 in the group mode are stored in the memory 13 within the USB key 1, and the personal computer 2 reads out the application program from the USB key 1 and activates the application program when the USB key 1 is attached to the personal computer 2. The data guard program reads out the group ID from the memory 13 and judges the permission for use of the USB key 1. When the use thereof is allowed, the data guard program performs encryption. Accordingly, the user does not need to enter the group ID, facilitating the operation of using the USB key 1. Moreover, there is no likelihood that the group ID could not be seen by a third party, and high security can be obtained.

With the decryption device composed of the USB key 1 and the personal computer 2, the data guard program for operating the USB key 1 and the group ID for specifying the permission for use of the USB key 1 in the group mode are stored in the memory 13 within the USB key 1, and the personal computer 2 reads out the data guard program from the USB key 1 and activates the data guard program when the USB key 1 is attached to the personal computer 2. The data guard program reads out the group ID from the memory 13 and judges the permission for use of the USB key 1. When the use thereof is allowed, the data guard program performs decryption. Accordingly, the user does not need to enter the group ID, facilitating the operation of using the USB key 1. Moreover, there is no likelihood that the group ID could be seen by a third party, and high security can be obtained.

The pseudorandom number generator 14 is provided within the USB key 1, which is a unit separate from the personal computer 2. Only when encryption is performed, the USB key 1 is attached to the personal computer 2 and the pseudorandom number is sent from the USB key 1 to the personal computer 2. In other words, the pseudorandom number generator 14 (encryption algorithm) is not resident in the personal computer 2 but incorporated in the USB key 1 body. This makes it difficult for a third party to decrypt the pseudorandom number as the cryptographic key. Accordingly, it is possible to prevent the third person from browsing data on an individual personal computer.

Only if the USB key 1 is inserted to the personal computer 2 when used, various types of files including documents and images can be encrypted. Furthermore, if a partner has the USB key 1, it is possible to send a secret cryptographic mail composed of encrypted data to the partner.

Moreover, the personal computer 2 is not provided with the pseudorandom number generator 14, thus reducing the processing load on the personal computer 2. Furthermore, the encryption process is not performed when the password on the USB key 1 side does not match the password on the personal computer 2 side, thus further improving the confidentiality.

Moreover, a plurality of types of pseudorandom numbers can be generated by changing the group ID as the initial value of the encryption function. Accordingly, a plurality of types of the USB key 1 can be produced, thus allowing use by a plurality of groups.

(Second Embodiment)

Next, a description is given of an encryption key device according to a second embodiment of the present invention and an encryption device using the same. The encryption key device according to the second embodiment of the present invention and the encryption device using the same are configured to automatically store encrypted data obtained by encryption in the encryption key device.

The configurations of the encryption key device according to the second embodiment of the present invention and the encryption device using the same are the same as those of the first embodiment shown in FIG. 1. The type of data stored in the memory 13 of the USB key 1 and operations of the USB key 1 and the personal computer 2 are different from those of the first embodiment. The following description is mainly given of part different from the first embodiment.

FIG. 9 is a view showing a structure of the memory 13 of the USB key 1, and an automatic encryption setting information is added to the memory 13 (see FIG. 2) of the USB key 1 according to the first embodiment. The automatic encryption setting information specifies whether the encrypted data obtained by encryption is automatically stored in the data area of the memory 13.

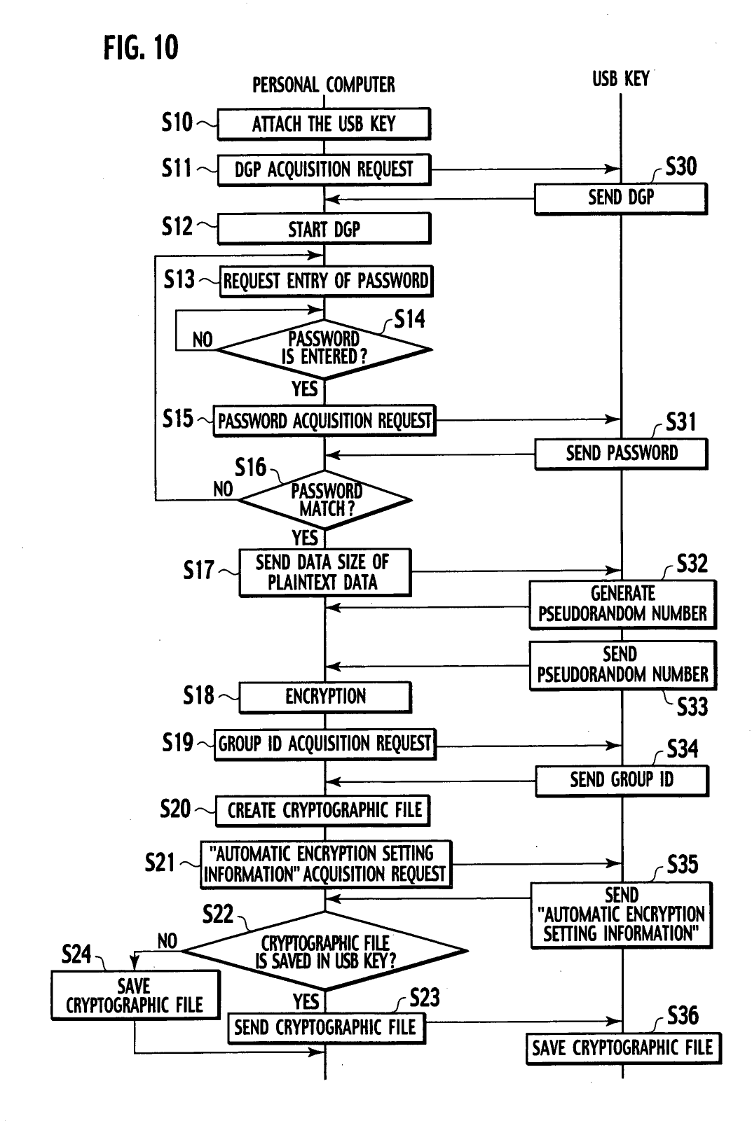

Next, a description is given of operations of the thus configured encryption key device according to the second embodiment of the present invention and the encryption device using the same with reference to a sequence diagram shown in FIG. 10. Processes same as the encryption process according to the first embodiment are given same numerals as those shown in FIG. 2, and the description thereof is omitted.

In FIG. 10, the processes in the steps S10 to S20 and in the steps S30 to S34 are the same as those shown in FIG. 3. The description of these processes is omitted, and the processes in the step S21 and subsequent steps are described.

First, the personal computer 2 sends a request to acquire the automatic encryption setting information to the USB key 1 (step S21). In the USB key 1 having received the automatic encryption setting information acquisition request, the USB controller 12 reads the automatic encryption setting information from the memory 13 and sends the same to the personal computer 2 (step S35).

In the personal computer 2 having received the automatic encryption setting information, the controller 22 examines whether the automatic encryption setting information specifies the USB key 1 as a destination where the cryptographic file is saved (step S22). When it is judged that the USB key 1 is specified as the destination where the cryptographic file is saved in this step S22, the personal computer 2 sends the cryptographic file to the USB key 1 (step S23). In the USB key 1 having received the cryptographic file, the USB controller 12 saves the received cryptographic file in the data area of the memory 13 (step S36).

On the other hand, when it is judged the USB key 1 is not specified as the destination where the cryptographic file is saved in this step S22, the personal computer 2 saves the cryptographic file in a memory within the personal computer 2 specified by the entry unit 3 (step S24).

As described above, with the USB key as the encryption key device according to the second embodiment of the present invention, the data guard program to operate the USB key 1, the group ID specifying the permission of the USB key 1, and the automatic encryption setting information specifying the destination where the encrypted data is saved are stored in the memory 13, and the memory 13 includes the data area, where data can be written. Accordingly, the data guard program operating when the USB key 1 is attached to the personal computer 2 can be configured to determine the destination where the encrypted data is saved to be the memory of the USB key 1 based on the automatic encryption setting information. In this case, the user does not need to specify where to save the encrypted data, thus facilitating the operation of using the USB key 1. Moreover, there is no likelihood that the encrypted data could be seen by a third party, and high security can be obtained.

With the encryption device composed of the USB key 1 and the personal computer 2, the USB key 1 stores in the memory 13 the data guard program to operate the USB key 1, the group ID specifying the permission for use of the USB key 1, and the automatic encryption setting information specifying the destination where the encrypted data is saved, and the memory 13 includes the data area where data can be written. Accordingly, the data guard program operating when the USB key 1 is attached to the personal computer 2 can determine the destination where the encrypted data is saved to be the memory 13 of the USB key 1 based on the automatic encryption setting information. The user therefore does not need to specify where to save the encrypted data, facilitating the operation for using the USB key 1. Moreover, the cryptographic file is saved in the USB key 1, and there is no likelihood that the encrypted data could be seen by a third party, and high security can be obtained.

(Third Embodiment)

Next, a description is given of an encryption key device according to a third embodiment of the present invention and a decryption device using the same. The encryption key device according to the third embodiment of the present invention and the decryption device using the same are configured to automatically store the plaintext data obtained by decryption in the encryption key device.

The configurations of the encryption key device according to the third embodiment of the present invention and the decryption device using the same are the same as those of the first embodiment shown in FIG. 1, but the type of data stored in the memory 13 of the USB key 1 and the operations of the USB key 1 and the personal computer 2 are different from those of the first embodiment. The following description is mainly given of part different from the first embodiment.

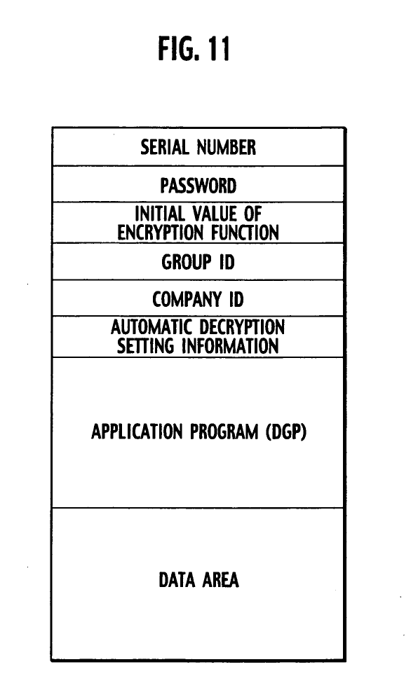

FIG. 11 is a view showing a configuration of the memory 13 of the USB key 1, and automatic decryption setting information is added to the memory 13 (see FIG. 2) of the USB key 1 according to the first embodiment. The automatic decryption setting information is information specifying whether the plaintext data obtained by decryption is automatically stored in the data area of the memory 13.

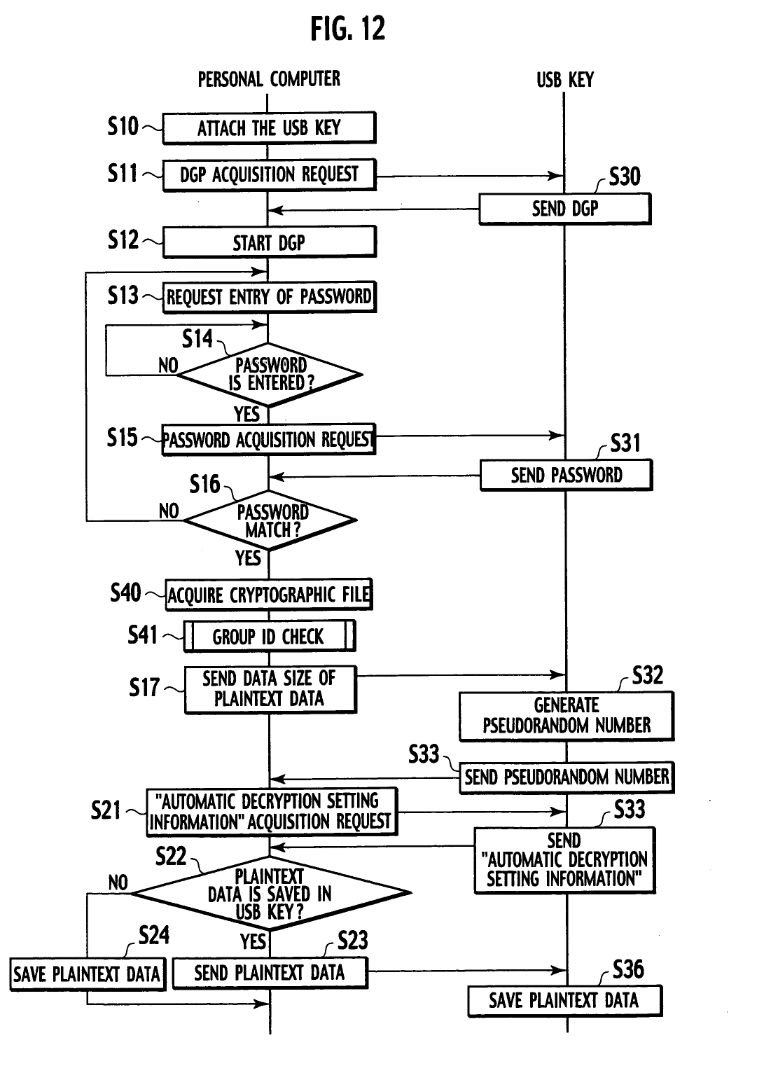

Next, a description is given of the operations of the encryption key device according to the third embodiment of the present invention and the decryption device using the same with reference to a sequence diagram shown in FIG. 12. Processes same as the decryption processes according to the first embodiment are given same numerals as those shown in FIG. 2, and the description thereof is simplified.

In FIG. 12, the processes in the steps S10 to S17 and steps S30 to S33 are the same as those shown in FIG. 6. The description thereof is omitted, and the step S21 and the subsequent steps are described.

The personal computer 2 sends the automatic decryption setting information acquisition request to the USB key 1 (step S21). In the USB key 1 having received the automatic decryption setting information acquisition request, the USB controller 12 reads the automatic decryption setting information from the memory 13 and sends the same to the personal computer 2 (step S35).

In the personal computer 2 having received the automatic decryption setting information, the controller 22 examines whether the automatic decryption setting information specifies the USB key 1 as the destination where the plaintext data is saved (step S22). When it is judged that the USB key 1 is specified as the destination where the plaintext data is saved in this step S22, the personal computer 2 sends the plaintext data to the USB key 1 (step S23). In the USB key 1 having received the plaintext data, the USB controller 12 saves the received plaintext data in the data area of the memory 13 (step S36).

On the other hand, when it is judged that the USB key 1 is not specified as the destination where the plaintext data is saved in the step S22, the personal computer 2 saves the plaintext data in the memory within the personal computer 2 specified by the entry unit 3 (step S24).

As described above, with the USB key 1 as the encryption key device according to the third embodiment of the present invention, the data guard program to operate the USB key 1, the group ID specifying the permission for use of the USB key 1, and the automatic decryption setting information specifying the destination where the plaintext is saved are stored in the memory 13, and the memory 13 includes the data area where data can be written. Accordingly, the data guard program operating when the USB key 1 is attached to the personal computer 2 can be configured to determine the destination where the plaintext data is saved to be the memory of the USB key 1 based on the automatic decryption setting information. In this case, the user does not need to specify where to save the plaintext data, facilitating the operation of using the USB key 1. In addition, there is no likelihood that the plaintext data could be seen by a third party, and high security can be obtained.

With the decryption device composed of the USB key 1 and the personal computer 2, the USB key 1 stores in the memory 13 of the USB key 1 the data guard program to operate the USB key 1, the group ID specifying the permission for use of the USB key 1, and the automatic decryption setting information specifying the destination where the plaintext is saved, and the memory 13 includes the data area where data can be written. Accordingly, the data guard program operating when the USB key 1 is attached to the personal computer 2 can determine the destination where the plaintext data is saved to be the memory 13 of the USB key 1 based on the automatic decryption setting information. The user therefore does not need to specify where to save the plaintext data, facilitating the operation of using the USB key 1. In addition, there is no likelihood that the plaintext data could be seen by a third party, and high security can be obtained.

(Fourth Embodiment)

An encryption key device according to a fourth embodiment of the present invention (including an encryption key device in the case of being used as a part of the encryption device or decryption device) is configured such that a memory is freely attached and detached to the body of the encryption key device.

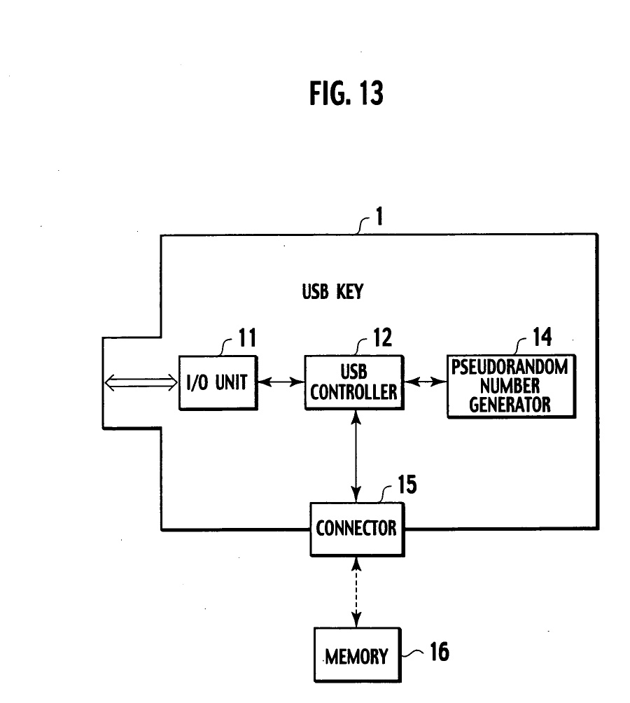

FIG. 13 is a block diagram showing a configuration of a USB key as an encryption key device according to the fourth embodiment of the present invention. This USB key 1 includes an input/output unit 11, a USB controller 12, a pseudorandom number generator 14, and a connector 15. The connector 15 is provided with a memory 16 to be freely attached to and detached from the connector 15. The configuration of the memory 16 is the same as the memory 13 of the first, second, or third embodiment.

With the USB key 1 according to the fourth embodiment, the body of the USB key 1 can be manufactured in common, and costs for manufacturing the USB key 1 can be reduced. The memory 16 can be configured to be held by each user, thus further enhancing the security.

1. An encryption key device capable of being freely attached to and detached from an information processor encrypting or decrypting data, comprising:
a memory configured to store an application program to operate the encryption key device and a group ID specifying permission for use of the encryption key device;
a pseudorandom number generator configured to generate a pseudorandom number according to an encryption function using the group ID stored in the memory as an initial value of the encryption function; and
a controller configured to cause the pseudorandom number generator to generate a pseudorandom number according to data size received from the information processor operating according to the application program and sending the generated pseudorandom number and the group ID read from the memory to the information processor.

2. An encryption device comprising:
an information processor configured to encrypt data; and
an encryption key device capable of being freely attached to and detached from the information processor,
wherein the encryption key device includes:
a memory configured to store an application program to operate the encryption key device and a group ID specifying permission for use of the encryption key device; and
a pseudorandom number generator configured to generate a pseudorandom number according to an encryption function using the group ID stored in the memory as an initial value of the encryption function, and
the information processor reads the application program from the memory of the encryption key device to activate the application program when the encryption key device is attached thereto and sends data size of not-encrypted plaintext data to the encryption key device by processing of the activated application program,
the encryption key device causes the pseudorandom number generator to generate a pseudorandom number according to the data size received from the information processor and sends the generated pseudorandom number to the information processor, and
the information processor encrypts the plaintext data using the pseudorandom number sent from the encryption key device as a key and adds the group ID read from the memory of the encryption key device to encrypted data generated by the encryption to generate a cryptographic file.

3. A decryption device comprising:
an information processor configured to decrypt data; and
an encryption key device capable of being freely attached to and detached from the information processor,
wherein the encryption key device includes:
a memory configured to store an application program to operate the encryption key device and a group ID specifying permission for use of the encryption key device; and
a pseudorandom number generator configured to generate a pseudorandom number according to an encryption function using the group ID stored in the memory as an initial value of the encryption function, and
the information processor reads the application program from the memory of the encryption key device to activate the application program when the encryption key device is attached thereto and sends data size of encrypted data included in a cryptographic file to the encryption key device by processing of the activated application program, and
the encryption key device causes the pseudorandom number generator to generate a pseudorandom number according to the data size received from the information processor and sends the generated pseudorandom number and the group ID read from the memory to the information processor, and
the information processor decrypts the encrypted data using the pseudorandom number sent from the encryption key device as a key when the group ID sent from the encryption key device matches the group ID included in the cryptographic file to generate plaintext data.

4. An encryption key device capable of being freely attached to and detached from an information processor encrypting and decrypting data, comprising:
a memory configured to store an application program to operate the encryption key device, a group ID specifying permission for use of the encryption key device, and automatic encryption setting information specifying a destination where encrypted data encrypted is saved and including a data area where data can be written;
a pseudorandom number generator configured to generate a pseudorandom number according to an encryption function using the group ID stored in the memory as an initial value of the encryption function; and
a controller configured to cause the pseudorandom number generator to generate the pseudorandom number according to data size received from the information processor operating according to the application program when the encryption key device is attached to the information processor, sending the generated pseudorandom number and the group ID read from the memory to the information processor, and controlling exchange of data between the data area of the memory and the information processor.

5. An encryption device, comprising:
an information processor configured to encrypt data; and
an encryption key device capable of being freely attached to and detached from the information processor, wherein
the encryption key device includes:
a memory configured to store an application program to operate the encryption key device, a group ID specifying permission for use of the encryption key device, and automatic encryption setting information specifying a destination where encrypted data encrypted is saved and including a data area which data can be written; and
a pseudorandom number generator configured to generate a pseudorandom number according to an encryption function using the group ID stored in the memory as an initial value of the encryption function, and
the information processor reads an application program from the memory of the encryption key device to activate the application program when the encryption key device is attached thereto and sends data size of not-encrypted plaintext data to the encryption key device by processing of the activated application program, and
the encryption key device causes the pseudorandom number generator to generate the pseudorandom number according to the data size received from the information processor and sends the generated pseudorandom number to the information processor, and
the information processor encrypts the plaintext data using the pseudorandom number sent from the encryption key device as a key, adds a group ID read from the memory of the encryption key device to encrypted data generated by the encryption to generate a cryptographic file, and sends the generated cryptographic file to the data area of the memory when the automatic encryption setting information read from the memory of the encryption key device specifies the memory of the encryption key device as a destination where the cryptographic file is saved.

6. A decryption device comprising:
an information processor configured to decrypt data; and
an encryption key device capable of being freely attached to and detached from the information processor, wherein
the encryption key device includes:
a memory configured to store an application program to operate the encryption key device, a group ID specifying permission for use of the encryption key device, and automatic decryption setting information specifying a destination where plaintext data decrypted is saved and including a data area where data can be written; and
a pseudorandom number generator configured to generate a pseudorandom number according to an encryption function using the group ID stored in the memory as an initial value of the encryption function, and
the information processor reads an application program from the memory of the encryption key device to activate the application program when the encryption key device is attached thereto and sends data size of encrypted data included in a cryptographic file to the encryption key device by processing of the activated application program, and
the encryption key device causes the pseudorandom number generator to generate the pseudorandom number according to the data size received from the information processor and sends the generated pseudorandom number and a group ID read from the memory to the information processor, and
the information processor decrypts the encrypted data using the pseudorandom number sent from the encryption key device as a key to generate plaintext data when the group ID sent from the encryption key device matches the group ID included in the cryptographic file and sends the generated plaintext data to the data area of the memory when the automatic decryption setting information read from the memory of the encryption key device specifies the memory of the encryption key device as a destination where the generated plaintext data is saved.

7. The encryption key device according to claim 1, wherein the memory is freely attached to and detached from a body of the encryption key device.
